(19) United States
(12) Patent Application Publication
(10) Pub. No.: US 2015/0205641 A1
(43) Pub. Date: Jul. 23, 2015

(54) DATA READING METHOD, ELECTRONIC DEVICE AND STORAGE MEDIUM

(71) Applicant: Tencent Technology (Shenzhen) Company Limited, Shenzhen (CN)

(72) Inventor: Hui Wang, Shenzhen (CN)

(21) Appl. No.: 14/413,682

(22) PCT Filed: Sep. 3, 2013
(86) PCT No.: PCT/CN2013/082864

§ 371 Date: Jan. 8, 2015

(30) Foreign Application Priority Data
Sep. 24, 2012 (CN) 201210358286.1

(51) Int. Cl. G06F 9/50; G06F 9/48

(52) U.S. Cl. CPC G06F 9/5088; G06F 9/4881

(57) ABSTRACT

The present disclosure relates to a data reading method, electronic device and storage medium. The data reading method includes steps of: receiving a read request, and using feedback data of an aggregate process to respond to the read request so as to obtain a response result; and based on the response result, determining feedback data of the read request obtained from the aggregate process or a service process. The present disclosure further provides an electronic device and storage medium. The data reading method, electronic device and storage medium of the disclosure shunt data of a service process heavily burdened so as to reduce load of the service process.

The present application claims the priority benefit of Chinese Patent Application No. 201210358286.1 entitled “DATA READING METHOD, ELECTRONIC DEVICE AND STORAGE MEDIUM” and filed to the State Intellectual Property Office on Sep. 24, 2012, the contents of which are incorporated by reference herein in their entirety.

### FIELD OF THE INVENTION

The disclosure relates to the technical field of computer, and particularly, to a data reading method, electronic device and storage medium based on UGC (User Generated Content).

### BACKGROUND

UGC is a new way for a user to use Internet, which focuses on both of download and upload, rather than taking precedence on download as in a traditional fashion. The main application forms of UGC include social network, video sharing, blog and so on. With diversity of smart terminals and development of global Internet service, UGC service is rising gradually, which draws wide attention in the industry.

FIG. 1 is a structural schematic diagram showing the structure of a UGC-based data reading device. The data reading device includes an interface process 11 and a plurality of service processes 12, wherein the interface process 11 is configured to route a read request to a corresponding service process 12. Since a read request may involve a plurality of service processes 12, the interface process 11 is also responsible for integrating data of the plurality of service processes 12. Each service process 12 performs corresponding user data reading and writing in response to the read request from the interface process 11.

When a prior UGC-based data reading device is in use, if the interface process 11 receives a read request for a microblog homepage, it will separate the read request into plural sub-read-requests to send to a service process 12 respectively. Upon receipt of the sub-read-request, a service process 12 will feed corresponding response data back to the interface process 11. The interface process 11 integrates plural response data and feeds them back to the user. Since the microblog homepage of every user generally includes microblog information of several followed friends, if the user conducts frequent operation on the microblog homepage, such as page up or page down, etc., in order to refresh contents of the microblog homepage, the interface process 11 and plural service processes 12 will have to make data communication continuously, laying heavy burden on corresponding service processes.

Besides, some microblog users may have a huge amount of listener users (for example, a verified celebrity user). In this case, it is very likely that the server on which the service process 12 of the verified celebrity user locates becomes a hotspot, which also makes the corresponding service process 12 heavily burdened.

### SUMMARY OF THE INVENTION

### Technical Problem

One object of the disclosure is to provide a data reading method, electronic device and storage medium for shunting data of a service process heavily burdened so as to reduce load of the service process, which solves a technical problem that some service processes of prior data reading method and device are heavily burdened.

### Solution to the Problem

### Technical Solution

In order to solve the above problem, the technical solution provided by the present disclosure is as follows.

The present disclosure provides a data reading method, including steps of:

receiving a read request, and using feedback data of an aggregate process to respond to the read request so as to obtain a response result; and

based on the response result, determining feedback data of the read request obtained from the aggregate process or a service process, wherein the read request includes a first read request,

wherein the feedback data of the aggregate process may be acquired via the following steps:

receiving the first read request and sending the first read request to the service process;

based on stored user data of a user, using the service process to respond to the first read request and using the service process to generate feedback data; and

receiving feedback data of the service process, sending service data among the feedback data of the service process to the user end, and sending the feedback data of the service process to the aggregate process.

The present disclosure further provides an electronic device, including:

one or more processors;

a memory; and

one or more programs stored in the memory and configured to be executed by the one or more processors to provide a data reading method, the one or more programs, divided by function, including:

a service process, configured to store user data of a user to respond to a first read request;

an aggregate process, configured to store feedback data of the service process to respond to a second read request; and

an interface process, including:

a service interface sub-process, configured to: receive the first read request and send the first read request to the service process; receive feedback data of the service process and send service data among the feedback data of the service process to the user end; and

an aggregate interface sub-process, configured to: send the feedback data of the service process to the aggregate process; receive the second read request and send the second read request to the aggregate process; receive feedback data of the aggregate process and send the feedback data of the aggregate process to the user end.

The present disclosure further provides a storage medium storing instructions executable by a processor, the processor, by executing the instructions, provides a data reading method including:

receiving a read request, and using feedback data of an aggregate process to respond to the read request so as to obtain a response result; and

based on the response result, determining feedback data of the read request obtained from the aggregate process or a service process,

wherein the read request includes a first read request,

wherein the feedback data of the aggregate process may be acquired via the following steps:

receiving the first read request and sending the first read request to the service process;

based on stored user data of a user, using the service process to respond to the first read request and using the service process to generate feedback data; and receiving feedback data of the service process, sending service data among the feedback data of the service process to the user end, and sending the feedback data of the service process to the aggregate process.

### Advantageous Effects of the Disclosure

### Advantageous Effects

Compared with prior arts, the data reading method, electronic device and storage medium of the disclosure shunt data of a service process heavily burdened so as to reduce load of the service process, which solves a technical problem that some service processes of prior data reading method and device are heavily burdened.

### DESCRIPTION OF THE DRAWINGS

In order to more clearly illustrate the technical solutions of the embodiments of the disclosure or prior arts, accompanying drawings used in description of the embodiments or prior arts will be briefly described in the following. Obviously, the drawings described herein are only embodiments of the disclosure, and those skilled in the art may achieve other drawings based on these drawings without creative work.

FIG. 1 is a structural schematic diagram of a prior UGC-based data reading device;

FIG. 2 is a structural schematic diagram of the working environment of the electronic device of the present disclosure;

FIG. 3 is a structural schematic diagram of a preferred embodiment of the electronic device of the present disclosure;

FIG. 4 is a flow chart of a preferred embodiment of the data reading method of the present disclosure;

FIG. 5 is a flow chart in which the aggregate process of the preferred embodiment of the data reading method of the present disclosure acquires feedback data; and

FIG. 6 is an exemplary diagram of the use of the data reading method and corresponding electronic device of the present disclosure.

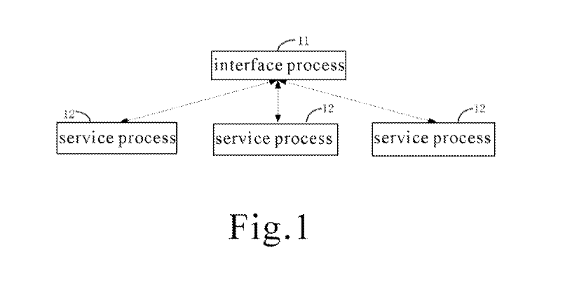

### DETAILED DESCRIPTION

Referring to the figures, wherein the same reference numbers for components represent the same components, the principle of the disclosure will be illustrated while implemented in a suitable computing environment. The following description is based on specific embodiments of the disclosure illustrated, which shall not be construed as limit other specific embodiments of the disclosure not detailed herein.

In the following description, specific embodiments of the disclosure will be described by referring to steps of operations performed by one or more computers and reference numbers, unless otherwise stated. Therefore, as will be appreciated, these steps and operations being performed by computer, as mentioned for several times, include being handled by computer processing units which represent an electronic signal of data in a structured form. Such handling converts the data or maintains the data at a location in a memory system of the computer, which may re-configure operation of the computer or otherwise change operation of the computer in a way known to those skilled in the art. The data structure maintained by the data is an entity location of the memory, which has specific characteristics defined by the data format. However, the principle of the disclosure described in above terms is not intended to be limiting; as will be understood by those skilled in the art, a plurality of steps and operations as below may also be implemented in hardware.

Terms such as “component”, “module”, “system”, “interface”, “process” etc. used in the present application are generally intended to refer to computer related entity, hardware, a combination of hardware and software, software or software in execution. For instance, a component may be, but not limited to, a process running on a processor, processor, object, executable application, executed thread, program and/or computer. By illustration, both an application running on a controller and the controller may be components. One or more components may be located within an executed process and/or thread, and a component may be located on a computer and/or distributed among two or more computers.

Furthermore, the claimed subject matter may be implemented as using standard programming and/or industry technology enabling software, firmware, hardware or any combination thereof to control a computer to realize the method, device or product disclosed. Term “product” used herein is intended to comprise a computer program accessible from any computer readable device, carrier or medium. Of course, those skilled in the art will recognize that a number of modifications may be made to the configuration without departing from the scope or spirit of the claimed subject matter.

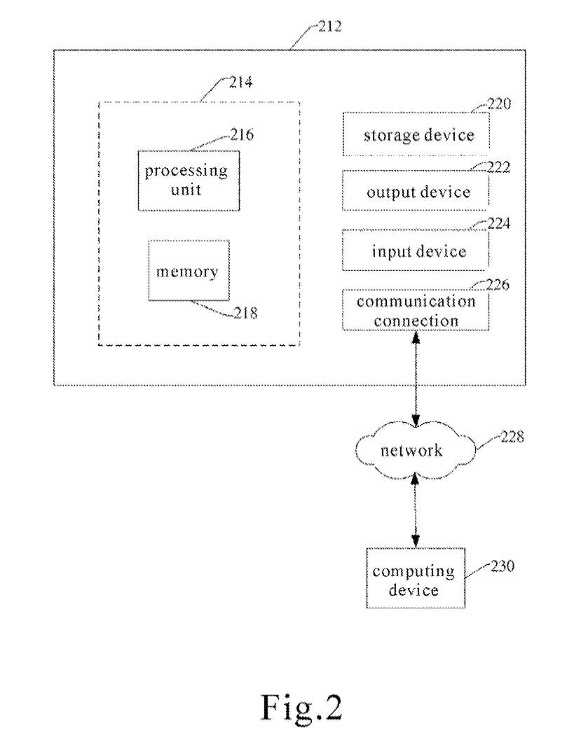

FIG. 2 and the discussion followed provide a brief and summarized description of the working environment in which the electronic device of the present disclosure is implemented. The working environment in FIG. 2 is merely an exemplary suitable working environment and not intended to suggest any limit to the usage or scope of function of the working environment. The exemplary electronic device 212 may include, but not limited to, a personal computer, server computer, handheld or laptop device, mobile device (such as mobile phone, Personal Digital Assistant (PDA), media player, etc.), multi-processor system, consumer electronic device, minicomputer, large-scale computer, distributed computing environment including any of the system or device mentioned above, and the like.

While not required, embodiments are described on a common background in which “computer readable instructions” are executed by one or more electronic devices. Computer readable instruction may be distributed via computer readable medium (as discussed hereinafter). Computer readable instruction may be implemented as a program module, such as a data structure, application programming interface (API), object, function which performs a specific task or realizes a specific abstract data type etc. Typically, the function of computer readable instructions may be combined arbitrarily or distributed in various environments.

FIG. 2 illustrates an exemplary electronic device 212 including one or more embodiments of the data reading method of the disclosure. In one configuration, the electronic device 212 may include at least one processing unit 216 and memory 218. According to the specific configuration and type of the electronic device, memory 218 may be volatile (e.g., RAM), non-volatile (e.g., ROM, flash memory, etc.) or a combination of the both. The configuration is shown by dash line 214 in FIG. 2.

In another embodiment, the electronic device 212 may include additional features and/or functions. For instance, device 212 may further include an additional storage device (e.g., removable or irremovable), which may include but not limited to a magnetic storage device, optical storage device and so on. Such additional storage device is illustrated by storage device 220 in FIG. 2. In one embodiment, computer readable instruction for implementing one or more embodiments provided in the disclosure may be in the storage device 220. Storage device 220 may further store other computer readable instructions for realizing operating system, application program etc. Computer readable instructions may be loaded into memory 218 for execution by a processing unit 216 for example.

Term “computer readable medium” used herein may include computer storage medium. Computer storage medium may include volatile and non-volatile, removable and irremovable medium implemented in any method or technique for storing information such as computer readable instructions or other data. Memory 218 and storage device 220 are instances of computer storage medium. Computer storage medium may include, but not limited to, RAM, ROM, EEPROM, flash memory or other memory technique, CD-ROM, digital versatile disk (DVD) or other optical storage device, cassette, tape, magnetic disk storage device or other magnetic storage means, or any other medium configured to store expected information and accessible by the electronic device 212. Any such computer storage medium may be a part of the electronic device 212.

The electronic device 212 may further include a communication connection 226 enabling the electronic device 212 to communicate with other devices. The communication connection 226 may include but not limited to modem, network interface card (NIC), integrated network interface, radio frequency transmitter/receiver, infrared port, USB connection or other interfaces for connecting the electronic device 212 to other electronic devices. The communication connection 226 may include a wired connection or wireless connection. The communication connection 226 may transmit and/or receive communication media.

Term “computer readable medium” may include communication medium. Communication medium may typically contain computer readable instructions or other data in “a modulated data signal” such as carrier or other transporting mechanism, and may include any information delivering medium. Term “modulated data signal” may include such a signal: one or more characteristics of the signal will be set or changed in the way in which information is encoded into the signal.

The electronic device 212 may include an input device 224 such as a keyboard, mouse, stylus, voice input device, touch input device, infrared camera, video input device and/or any other input device. Device 212 may also include an output device 222 such as one or more display, speaker, printer and/or any other output device. Input device 224 and output device 222 may connect to the electronic device 212 via a wired connection, a wireless connection or any combination thereof. In one embodiment, an input device or output device from another electronic device may act as the input device 224 or output device 222 of the electronic device 212.

Components of the electronic device 212 may be connected via various interconnects (e.g., bus). Such interconnect may include periphery component interconnect (PCI) (e.g., fast PCI), universal serial bus (USB), FireWire (IEEE 1394), optical bus structure etc. In another embodiment, components of the electronic device 212 may be interconnected via network. For instance, memory 218 may consists of plural physical memory units located in different physical locations and interconnected via a network.

As will be appreciated by those skilled in the art, a storage device for storing computer readable instructions may be distributed across a network. For instance, an electronic device 230 accessible via network 228 may store computer readable instructions for realizing one or more embodiments provided in the disclosure. Electronic device 212 may access electronic device 230 and download some or all of the computer readable instructions for execution. Alternatively, electronic device 212 may download plural pieces of computer readable instructions on demand, or some instructions may be executed at electronic device 212 while others at electronic device 230.

The present disclosure provides various operations of embodiments. In one embodiment, the one or more operations may constitute computer readable instructions stored on one or more computer readable medium, which cause a computer device to perform the operations when executed by an electronic device. Description of the order of some or all of the operations shall not be construed as implying that these operations must be sequentially correlated. Those skilled in the art will understand an alternative ordering which has the advantage of the present description. Moreover, as will be understood, not all the operations are necessarily in existence in every embodiment provided in the disclosure.

Furthermore, term “preferred” used herein is intended to be taken for illustration, example or instance. None of the aspects or designs described as “preferred” herein is necessarily construed as more beneficial than other aspects or designs. On the contrary, the use of term “preferred” is intended to provide a concept in a specific way. Term “or” used in the present application is intended to refer to an inclusive “or”, rather than an exclusive one. That is to say, unless otherwise specified or clear from the context, “X uses A or B” refers to natural inclusion of any one of the permutation, that is, if X uses A, X uses B, or X uses both A and B, then “X uses A or B” is satisfied in any of the above examples.

Furthermore, while the present disclosure is shown and described in one or more implementations, equivalent modifications and alternations will occur to those skilled in the art based on their reading and understanding the present description and drawings. The present disclosure includes all such modifications and alternations, and is limited only by the scope of appending claims. Particularly, with respect to various functions performed by above components (such as elements, resources, etc.), terms used to describe such components are intended to correspond to any component that performs the specified function of the component (e.g., functionally equivalent) (unless indicated otherwise), even with a structure different from the disclosed structure described herein to perform the function in the exemplary implementation of the disclosure. Besides, while a particular feature of the disclosure has been disclosed relative to only one of several implementations, such a feature may be combined with one or more other features of other implementations that may be expected and beneficial for a given or specific application for example. Moreover, term “include”, “have”, “contain” or their variant is intended to be inclusive in a similar way to term “comprise” in term of their use in the Detailed Description and Claims.

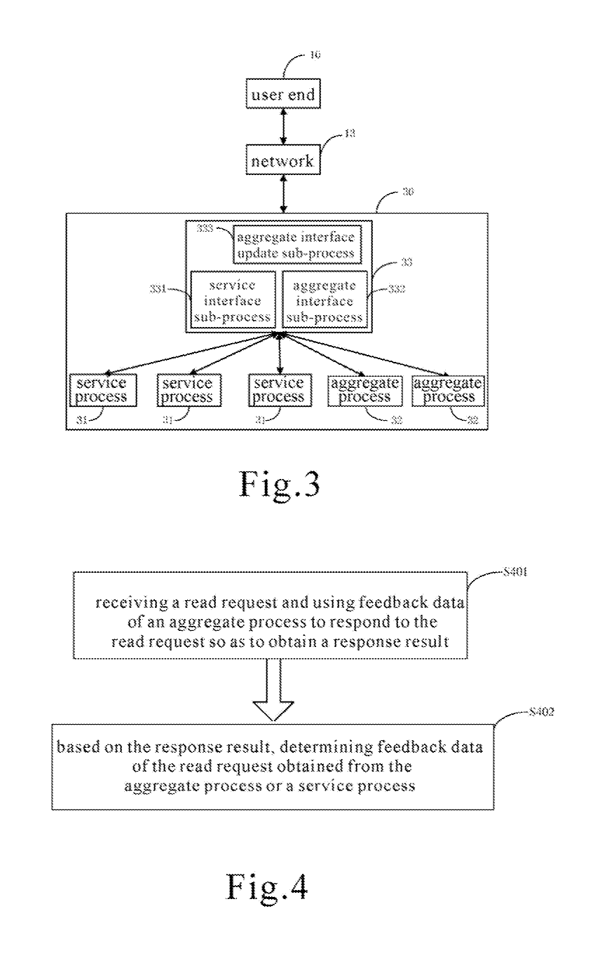

Refer to FIG. 3, which is a structural schematic diagram of a preferred embodiment of the electronic device of the present disclosure. The electronic device 30 may include one or more processors, memory, and one or more programs stored in the memory and configured to be executed by the one or more processors to provide a data reading method, the one or more programs, divided by function, including a plurality of service processes 31, a plurality of aggregate processes 32 and at least one interface process 33, wherein service process 31 is configured to store user data of a user to respond to a first read request, aggregate process 32 is configured to store feedback data of service process 31 to respond to a second read request. The electronic device 30 is communicatively connected to user end 10 via network 13.

The electronic device 30 may be the electronic device 212 in FIG. 2, which may include, but not limited to, a personal computer, server computer, handheld or laptop device, mobile device (such as mobile phone, PDA (Personal Digital Assistant), media player, etc.), multi-processor system, consumer electronic device, minicomputer, large-scale computer, distributed computing environment including any of the system or device mentioned above, and the like. In the present preferred embodiment, the electronic device 30 is preferably a server computer. Network 13 may include but not limited to a wired or wireless connection implemented by modem, network interface card (NIC), integrated network interface, radio frequency transmitter/receiver, infrared port, or USB connection. User end 10 may include, but not limited to, a personal computer, server computer, handheld or laptop device, mobile device (such as mobile phone, PDA (Personal Digital Assistant), media player, etc.), multi-processor system, consumer electronic device, minicomputer, large-scale computer, distributed computing environment including any of the system or device mentioned above, and the like. In the present preferred embodiment, the user end 10 is preferably a mobile device terminal.

In the present preferred embodiment, interface process 33 may include service interface sub-process 331, aggregate interface sub-process 332 and aggregate interface update sub-process 333. Service interface sub-process 331 is configured to: receive a first read request and send the first read request to service process 31; receive feedback data of service process 31 and send service data among the feedback data of service process 31 to user end 10. Aggregate interface sub-process 332 is configured to: send the feedback data of service process 31 to aggregate process 32; receive a second read request and send the second read request to aggregate process 32; receive feedback data of aggregate process 32 and send the feedback data of aggregate process 32 to user end 10. Aggregate interface update sub-process 333 is configured to: in case the feedback data of aggregate process 32 does not satisfy the second read request, send the second read request to service process 31; receive feedback data of service process 31, send service data among the feedback data of service process 31 to user end 10, and send the feedback data of service process 31 to aggregate process 32.

When the electronic device 30 of the disclosure is used, upon receiving a read request from a user, the electronic device 30 will differentiate the read request between a first read request and a second read request, wherein the first read request is typically a read request for a first access of the user within a certain period of time, and the second read request is typically a read request for continued access of the user within a certain period of time. When electronic device 30 is unable to differentiate the read request, the read request may be directly designated as a first read request or a second read request.

Processing of the first and second read requests will be described respectively as below.

First, the service interface sub-process 331 of the interface process 33 receives the first read request and sends the first read request to a corresponding service process 31 (each service process 31 stores user data of a specific user). The service process 31 responds to the first read request based on the user data it stores and sends corresponding feedback data to the interface process 33.

Next, the service interface sub-process 331 of the interface process 33 receives the feedback data, and sends service data among the feedback data to the user end 10.

The service data herein refers to data currently needed to the user end 10, whereas the feedback data sent by a service process 31 each time may be far more than the service data in amount (e.g., if a user browses a blog homepage to view the latest microblog of others, the microblog data on the blog homepage will be the service data, and data needed for the user to turn a page to view will be other feedback data, the other feedback data herein may be cached to accelerate browsing or set a page number to turn to, etc). Meanwhile, the aggregate interface sub-process 332 sends all the feedback data to the aggregate process 32, which will store these feedback data to respond to the second read request.

Subsequently, the user browses data according to the service data fed back by the service interface sub-process 331. At this time, the user end 10 may issue a second read request as necessary (such as a page turning operation, etc.), the aggregate interface sub-process 332 may send the second read request to the aggregate process 32; the aggregate process 32 may respond to the second read request based on the feedback data it stores and sends feedback data to the aggregate interface sub-process 332; the aggregate interface sub-process 332 may send the feedback data of the aggregate process 32 to the user end 10 to satisfy the user's demand for continued access.

Processing of the first and second read requests by the electronic device 30 of the disclosure has been described as above.

Preferably, when feedback data of the aggregate process 32 cannot satisfy the second read request (e.g., if the user refreshes his/her blog homepage to view other people's latest microblog, etc.), the interface update sub-process 333 will send the second read request to the service process 31, receive feedback data of the service process 31, send service data among the feedback data of the service process 31 to the user end 10, and send the feedback data of the service process to the aggregate process 32. The aggregate process 32 will update the feedback data it stores based on the feedback data received.

Preferably, in order to optimize the feedback speed of the aggregate process 32, the aggregate process 32 may also store an update time of user service data. In case feedback data of the aggregate process 32 cannot satisfy the second read request, the interface update sub-process 333 will simplify the second read request according to the update time of the user service data and a locate time when the second read request is issued. That is, the interface update sub-process 333 only reads data of a user whose update time of the user service data is later than the locate time when the second read request is issued, so that stress on the corresponding service process 31 can be reduced significantly without affecting the acquisition of feedback data. The locate time when the second read request is issued herein refers to the post time of the latest feedback data corresponding to the second read request in the aggregate process 32 when the second read request is issued (e.g., the post time of the latest microblog of a friend on the user's blog homepage). Subsequently, the interface update sub-process 333 sends a simplified second read request to a corresponding service process 31, receives feedback data of the service process 31, sends service data among the feedback data of the service process 31 to the user end 10, and sends the feedback data of the service process to the aggregate process 32. The aggregate process 32 will update the feedback data it stores based on the feedback data received.

Preferably, the aggregate process 32 may further include a first delete sub-process and a second delete sub-process. The first delete sub-process is configured to adopt an FIFO (First In, First Out) algorithm or a Least Recent Use algorithm to delete feedback data in the aggregate process 32. The second delete sub-process is configured to delete feedback data in the aggregate process 32 whose life time is longer than a preset value. The setting of the first delete sub-process guarantees validity of data in the aggregate process 32 (i.e., saving the latest feedback data of a corresponding user's or feedback data of the highest user access frequency). The setting of the second delete sub-process guarantees synchronization between data in the aggregate process 32 and data in the service process 31. For instance, if data in the service process 31 is deleted by a user, data in the aggregate process 32 will also be deleted after a certain life time, so that inconsistency between data in the aggregate process 32 and data in the service process 31 will not occur (since all the data in the aggregate process 32 come from the service process 31). Apparently, the algorithm used in the first delete sub-process herein and selection of a life time may be set in accordance with user's requirements, details of the algorithm and length of the life time are not intended to limit the scope of protection of the disclosure.

The present disclosure further provides a data reading method. As shown in FIG. 4 which is a flow chart of a preferred embodiment of the data reading method of the present disclosure, the data reading method may include:

Step S401: receiving a read request and using feedback data of an aggregate process to respond to the read request so as to obtain a response result;

Step S402: based on the response result, determining feedback data of the read request obtained from the aggregate process or a service process.

The data reading method ends in step S402.

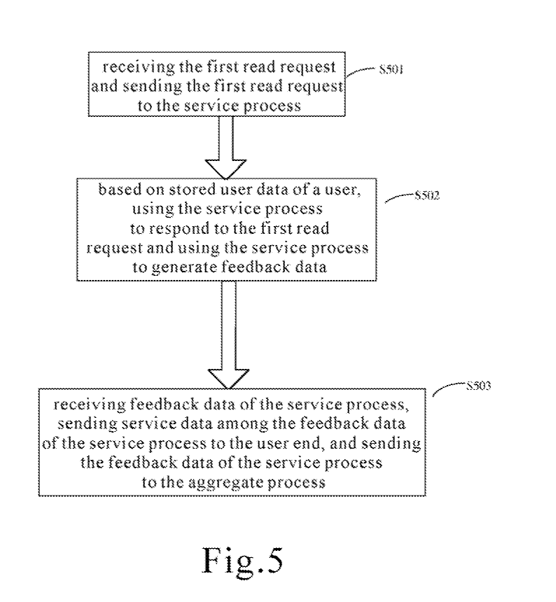

The read request may include a first read request.

Wherein the feedback data of the aggregate process may be acquired via the following steps as shown in FIG. 5 which is a flow chart in which the aggregate process of the preferred embodiment of the data reading method of the present disclosure acquires feedback data, including:

Step S501: receiving the first read request and sending the first read request to the service process;

Step S502: based on stored user data of a user, using the service process to respond to the first read request and using the service process to generate feedback data;

Step S503: receiving feedback data of the service process, sending service data among the feedback data of the service process to the user end 10, and sending the feedback data of the service process to the aggregate process.

The data reading method of the present disclosure may be used in an electronic device 30, the electronic device 30 including a plurality of service processes, a plurality of aggregate processes, and at least one interface process.

The read request may further include a second read request.

When the data reading method of the present disclosure is used, upon receiving a read request from a user, feedback data of an aggregate process will be used to respond to the read request.

If the read request is a first read request, feedback data of the aggregate process 32 does not satisfy the read request, and an interface process 33 will send the first read request to a service process 31; the service process 31 will respond to the first read request based on the user data it stores, and send corresponding feedback data to the interface process 33; after receiving the feedback data of the service process 31, the interface process 33 will send service data among the feedback data of the service process 31 to the user end 10, and send the feedback data of the service process to the aggregate process 32. The aggregate process 32 will store these feedback data to respond to a second read request.

If the read request is a second read request and feedback data of the aggregate process 32 satisfies the read request, the aggregate process 32 will respond to the second read request based on the feedback data it stores, and send the feedback data to the interface process 33; the interface process 33 will receive the feedback data of aggregate process 32 and send the feedback data of aggregate process 32 to the user end 10.

If feedback data of the aggregate process 32 does not satisfy the second read request, the interface process 33 will send the second read request to a service process 31, receive feedback data of the service process 31, send service data among the feedback data of the service process 31 to the user end 10, and send the feedback data of the service process to the aggregate process 32. The aggregate process 32 will update the feedback data it stores based on the feedback data received.

Preferably, in order to optimize the feedback speed of the aggregate process, the aggregate process 32 may also store an update time of user service data. In case feedback data of the aggregate process 32 cannot satisfy the second read request, the interface update sub-process 333 will simplify the second read request according to the update time of the user service data and a locate time when the second read request is issued. Subsequently, the interface process 33 sends a simplified second read request to a service process 31, receives feedback data of the service process 31, sends service data among the feedback data of the service process 31 to the user end 10, and sends the feedback data of the service process to the aggregate process 32. The aggregate process 32 will update the feedback data it stores based on the feedback data received.

Preferably, in the data reading method of the present disclosure, the aggregate process 32 may adopt an FIFO (First In, First Out) algorithm or a Least Recent Use algorithm to delete feedback data in the aggregate process, and delete feedback data in the aggregate process 32 whose life time is longer than a preset value. This guarantees validity of data in the aggregate process 32. Meanwhile, synchronization between data in the aggregate process 32 and data in service processes is guaranteed, so that inconsistency between data in the aggregate process 32 and data in service processes will not occur. Apparently, the algorithm used in the delete process herein and selection of a life time may be set in accordance with user's requirements, details of the algorithm and length of the life time are not intended to limit the scope of protection of the disclosure.

The specific use of the data reading method of the present disclosure is the same or similar as that of the specific embodiment of the above electronic device 30. Please refer to the specific embodiment of the above electronic device 30.

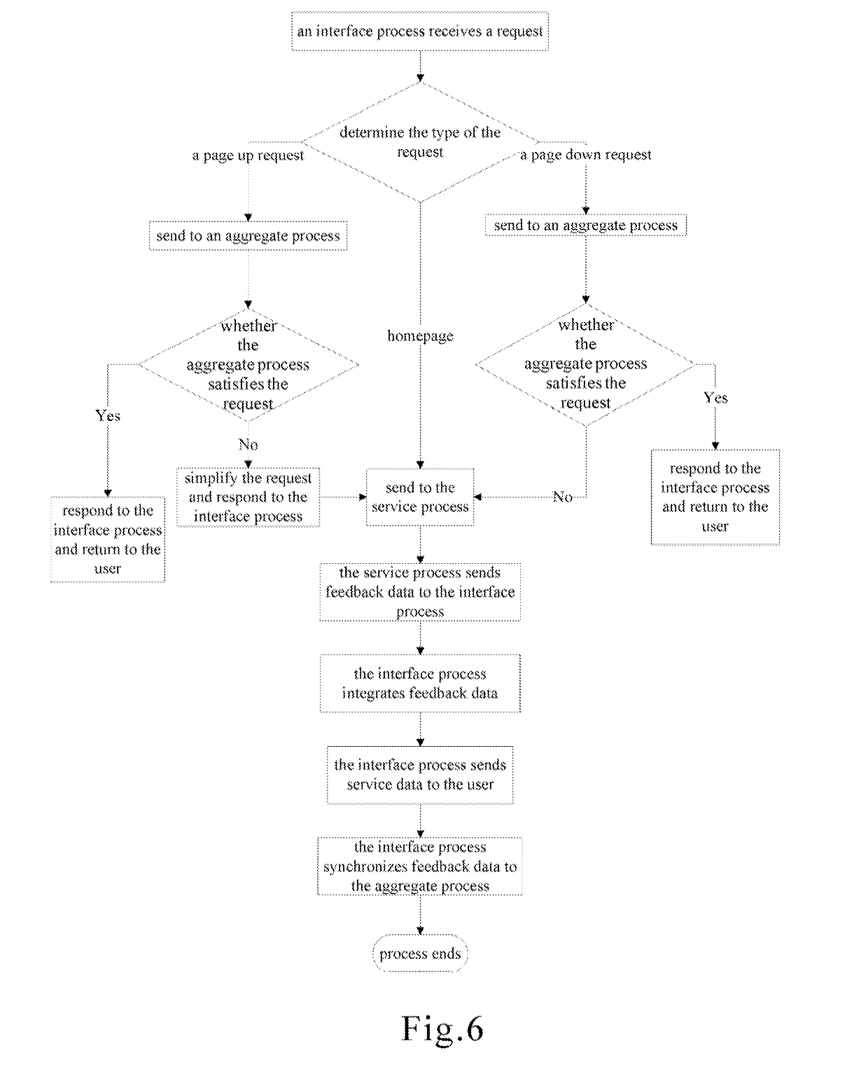

Below, the specific use of the electronic device and data reading method of the present disclosure will be described via a specific embodiment with reference to FIG. 6. FIG. 6 is an exemplary diagram of the use of the data reading method and corresponding electronic device of the present disclosure.

It is important to note that a service process is responsible for storing user data of a specific user, and an aggregate process only stores the latest data of a specific user and an update time of user service data. Therefore, the number of users for which an aggregate process is responsible is much larger than the number of users for which a service process is responsible.

First, an interface process determines the type of a request. Taking a personal blog as an example, if a user logs onto the homepage of the user's blog on that day, the interface process will need to display the latest microblog of his/her friend on the blog homepage. At this time, determining the read request as a first read request, the interface process sends the first read request to a service process, which will send feedback data corresponding to the request to the interface process.

If later, the user performs a page down operation, the read request will generally be set as a second read request (related to the first read request; generally, feedback data to respond to the second read request has been sent to an aggregate process when responding to the first read request). At this time, the interface process will send the second read request to the aggregate process, seeing if the aggregate process can satisfy the second read request. If yes, the aggregate process will send corresponding feedback data to the user end 10 in response to the interface process; if no (e.g., if the user pages down for too many times, data to be viewed exceeds the feedback data stored in the aggregate process), the second read request will be sent to a corresponding service process, which will send corresponding feedback data to the interface process.

If later, the user performs a page up operation, the read request will also generally be set as a second read request. At this time, the interface process will also send the second read request to the aggregate process, seeing if the aggregate process can satisfy the second read request. If yes, the aggregate process will send corresponding feedback data to the user end 10 in response to the interface process; if no (e.g., if the user performs a page up operation on the homepage, i.e., refreshes the latest microblog of a friend), users involved in this request will be simplified. For instance, if user A listens to the microblog of friend B and the microblog of friend C, and when user A refreshes his/her homepage microblog, only friend C has updated his/her microblog after the latest microblog post time of friends on the blog homepage of user A, the aggregate process will send a read request for microblog data of only friend C to a corresponding service process, which will send corresponding feedback data to the interface process.

Finally, the interface process will integrate service data among the feedback data to send to the user end 10, and meanwhile integrate all the feedback data to a corresponding aggregate process, so as to complete the whole data reading process.

As will be appreciated by those skilled in the art, some or all of the flows in the method of the above embodiment can be implemented by instructing relative hardware via a computer program, the program may be stored in a computer readable storage medium and when executed, may include the flows in the above method embodiments, wherein the storage medium may be magnetic disk, optical disk, Read-Only Memory (ROM), Random Access Memory (RAM), etc.

By adding an aggregate process, the data reading method, electronic device and storage medium of the present disclosure shunt data of prior service process well. Generally, after one homepage read request, a subsequent read request will be accomplished via an aggregate process, which reduces the read spreading extent of a read request significantly. The shunting effect is especially evident for the service process of a verified celebrity user, which reduces the probability of failure of the corresponding server. Moreover, an aggregate process only needs to store the latest data of a specific user and an update time of user service data, so its cost of implementation is rather low.

The data reading method, electronic device and storage medium of the disclosure shunt data of a service process heavily burdened so as to reduce load of the service process, which solves a technical problem that some service processes of prior data reading method and device are heavily burdened.

As mentioned above, while the present disclosure has been disclosed via preferred embodiments as above, the preferred embodiments are not intended to limit the disclosure. Those skilled in the art can make various modifications and alternations without departing from the spirit and scope of the disclosure. The scope of protection of the disclosure is defined by the claims.

1. A data reading method, including steps of:
receiving a read request, and using feedback data of an aggregate process to respond to the read request so as to obtain a response result; and
based on the response result, determining feedback data of the read request obtained from the aggregate process or a service process, wherein the read request includes a first read request, wherein the feedback data of the aggregate process is acquired via the following steps:
receiving the first read request and sending the first read request to the service process;
based on stored user data of a user, using the service process to respond to the first read request and using the service process to generate feedback data; and
receiving feedback data of the service process, sending service data among the feedback data of the service process to the user end, and sending the feedback data of the service process to the aggregate process,
wherein the read request further includes a second read request,
wherein the aggregate process is further configured to store an update time of user service data, and
wherein the step of based on the response result, determining feedback data of the read request obtained from the aggregate process or a service process further includes:
in case the feedback data of the aggregate process does not satisfy the second read request, simplifying the second read request according to the update time of the user service data and a locate time when the second read request is issued, sending a simplified second read request to a service process; receiving feedback data of the service process, sending service data among the feedback data of the service process to the user end, and sending the feedback data of the service process to the aggregate process.

2. The data reading method according to claim 1, wherein the step of based on the response result, determining feedback data of the read request obtained from the aggregate process or a service process includes:
in case the feedback data of the aggregate process satisfies the second read request, receiving the feedback data of the aggregate process and sending the feedback data of the aggregate process to the user end.

3.-6. (canceled)

7. The data reading method according to claim 1, further including a step of:
adopting a First-In-First-Out algorithm or a Least Recent Use algorithm to delete feedback data in the aggregate process.

8. The data reading method according to claim 1, further including a step of:
deleting feedback data in the aggregate process whose life time is longer than a preset value.

9. An electronic device, including:
one or more processors;
a memory; and
one or more programs stored in the memory and configured to be executed by the one or more processors to provide a data reading method, the one or more programs, divided by function, including:
a service process configured to store user data of a user to respond to a first read request;
an aggregate process configured to store feedback data of the service process to respond to a second read request; and
an interface process, including:
a service interface sub-process configured to: receive the first read request and send the first read request to the service process; receive feedback data of the service process; and send service data among the feedback data of the service process to a user end; and
an aggregate interface sub-process configured to: send the feedback data of the service process to the aggregate process; receive the second read request and send the second read request to the aggregate process; receive feedback data of the aggregate process and send the feedback data of the aggregate process to the user end,
wherein the aggregate process is further configured to store an update time of user service data, and
wherein the interface process further includes an aggregate interface update sub-process configured to:
in case the feedback data of the aggregate process does not satisfy the second read request, simplify the second read request according to the update time of the user service data and a locate time when the second read request is issued, send a simplified second read request to a service process; receive feedback data of the service process, send service data among the feedback data of the service process to the user end, and send the feedback data of the service process to the aggregate process.

10.-13. (canceled)

14. The electronic device according to claim 9, wherein the interface process further includes:
a first delete sub-process configured to adopt a First-In-First-Out algorithm or a Least Recent Use algorithm to delete feedback data in the aggregate process.

15. The electronic device according to claim 9, wherein the interface process further includes:
a second delete sub-process configured to delete feedback data in the aggregate process whose life time is longer than a preset value.

16. A storage medium storing instructions executable by a processor, the processor, by executing the instructions, provides a data reading method including:
receiving a read request, and using feedback data of an aggregate process to respond to the read request so as to obtain a response result; and
based on the response result, determining feedback data of the read request obtained from the aggregate process or a service process,
wherein the read request includes a first read request,
wherein the feedback data of the aggregate process is acquired via the following steps:
receiving the first read request and sending the first read request to the service process;
based on stored user data of a user, using the service process to respond to the first read request and using the service process to generate feedback data and
receiving feedback data of the service process, sending service data among the feedback data of the service process to the user end, and sending the feedback data of the service process to the aggregate process,
wherein the read request further includes a second read request,
wherein the aggregate process is further configured to store an update time of user service data, and
wherein based on the response result, determining feedback data of the read request obtained from the aggregate process or a service process further includes:
in case the feedback data of the aggregate process does not satisfy the second read request, simplifying the second read request according to the update time of the user service data and a locate time when the second read request is issued, sending a simplified second read request to a service process; receiving feedback data of the service process, sending service data among the feedback data of the service process to the user end, and sending the feedback data of the service process to the aggregate process.
